(19) United States
(12) Patent Application Publication
(10) Pub. No.: US 2006/0203028 A1
(43) Pub. Date: Sep. 14, 2006

(54) Apparatus and method for print quality control

(76) Inventors: Manish Agarwal, Singapore (SG); Xiaoxi Huang, Singapore (SG); Michael Nordlund, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/078,530

(22) Filed: Mar. 10, 2005

(51) Int. Cl. B41J 29/393

(52) U.S. Cl. 347/19

(57) ABSTRACT

A method is provided for print quality control. To carry out this method, a printing apparatus with optical detection capability is used. This apparatus includes: advance mechanism for advancing a print medium through a print zone; a carriage assembly having at least one pen for ejecting ink droplets onto the print medium in the print zone; an optical detection unit positioned in the print zone; and a printer controller. The optical detection unit includes an image acquisition module for capturing at least one image of the print zone within a field of view (FOV) and an image processor for performing a pixel array analysis of the captured image. The image analysis is triggered by the printer controller and the result of the analysis is fed back to the printer controller for controlling the printing operation.

### TECHNICAL FIELD

The present invention relates generally to printing systems and methods, and more particularly to apparatus and method for print quality control.

### BACKGROUND ART

Printing apparatuses, e.g. inkjet printers, plotters, photocopiers, facsimile machines, typically advance sheets of media, e.g. papers, through the print zone by media advancing mechanisms. The typical media advancing mechanism includes a drive roller that rotates about a drive shaft driven by a motor. With the advent of more complex print jobs, media positioning accuracy has become increasingly important.

Conventional inkjet printers implement an inkjet cartridge, called “pen” by those in the art, to eject droplets of ink onto a sheet of print medium. Inkjet printing mechanisms typically have a plurality of pens of various colors, e.g., cyan, magenta, yellow, and black. Each pen has a printhead formed with a plurality of small nozzles through which the ink droplets are ejected. The inks from the printheads are layered on the print media to obtain the desired color tone. The pens are typically mounted on a movable carriage. To print an image, the carriage traverses back and forth across the print medium in a direction traverse to the moving direction of the print medium. Each passage or sweep of the carriage across the print medium prints a “swath.” For each swath, the nozzles are fired to print groups of dots. Color printing and plotting generally require that ink from each pen be precisely applied to the print media. Defects in inkjet printers may arise from defects in the positioning of the pen, the carriage and the print media. In addition, other misalignments may arise due to the speed of the carriage, the curvature of the media support surface, imperfect nozzle shape, or imperfect nozzle placement.

Optical sensors have been incorporated into inkjet printers for detecting the discrete positioning of both the carriage and media, and for detecting defects associated with the printing mechanisms. Media sensors have also been used to detect the presence or absence of print media, and in some cases, also to determine the print media type. However, these sensors are typically limited in their capabilities because they can only perform a primary task due to their positions and the constraints of their simplified design. For example, the positional feedback sensors that are typically used for detecting the carriage and paper movement are dependent on the use of printer-mounted, graduated calibration strips for determining the positioning of pen cartridge(s) relative to the paper. Without the ability to directly sense the media, noise is introduced into the data in the form of media slippage and mechanism efficiency losses, which eventually lead to positioning inaccuracies. Furthermore, the mounting positions of the sensors are relevant only to the specific motion control subsystems and require complex algorithms to synchronize in order to maintain a high level of printing speed and overall print quality.

There exists a need for a simplified and reliable detection system that can be mounted on-board the printing apparatus and is capable of performing multiple functions including media movement detection, pen alignment detection, and media skew detection.

### SUMMARY OF THE INVENTION

A method is provided for print quality control. To carry out this method, a printing apparatus with optical detection capability is used. This apparatus includes: advance mechanism for advancing a print medium through a print zone; a carriage assembly having at least one pen for ejecting ink droplets onto the print medium in the print zone; an optical detection unit positioned in the print zone; and a printer controller. The optical detection unit includes an image acquisition module for capturing at least one image of the print zone within a field of view (FOV) and an image processor for performing a pixel array analysis of the captured image. The image analysis is triggered by the printer controller and the result of the analysis is fed back to the printer controller for controlling the printing operation.

The objects, aspects and advantages of the present invention will become apparent from the following detailed description, taken in conjunction with accompanying drawings.

### BRIEF DESCRIPTION OF THE DRAWINGS

FIG. 1 schematically shows an overview of a printing apparatus with optical detection capability according to an embodiment of the present invention

FIG. 2 shows a perspective view of the printing apparatus shown in FIG. 1.

FIG. 3 shows an optical detection unit according to an embodiment of the present invention.

FIG. 4 is a flowchart illustrating a method of monitoring the print medium movement according to an embodiment of the present invention.

FIGS. 5A and 5B show two sequentially captured images within a field of view (FOV).

FIG. 6 is a flowchart illustrating a method for edge detection according to one embodiment of the present invention.

FIG. 7 illustrates a field of view (FOV) that is positioned to detect the top edge of a print medium.

FIG. 8 illustrates a field of view (FOV) that is positioned to detect a side edge of a print medium.

FIG. 9 is a flowchart illustrating a skew detection method according to one embodiment of the present invention.

FIG. 10 illustrates a shift in position of the print medium from position A to position B relative to a statically positioned FOV when there is a skew.

FIGS. 11A and 11B show the captured images within a FOV for position A and position B, respectively.

FIG. 12 is a flowchart illustrating a method for media type detection according to one embodiment of the present invention.

FIG. 13A shows a captured image segmented into different zones for spectral analysis.

FIG. 13B is a graph showing how the spectral intensity patterns for plain, photographic and transparent media are different from one another.

FIG. 14 is a flowchart illustrating a method for determining an operational turn-on-energy according to one embodiment of the present invention.

FIG. 15 shows exemplary test patterns created by applying decreasing energy levels to a printhead and a FOV passing over the patterns.

FIG. 16 is a flowchart illustrating a pen alignment method according to one embodiment of the present invention.

FIG. 17A illustrates the difference between a correctly aligned pen position and a misaligned pen position with theta-X offset.

FIG. 17B shows the test patterns formed from pen positions shown in FIG. 17A.

FIG. 18A illustrates the difference between a correctly aligned pen position and a misaligned pen position with theta-Z offset.

FIG. 18B shows the test patterns formed from the pen positions shown in FIG. 18A.

FIG. 19A illustrates the difference between a correctly aligned pen position and a misaligned pen position with theta-Y offset.

FIG. 19B shows the test patterns formed from pen positions shown in FIG. 19A.

FIG. 20A illustrates a vertical pen-to-pen offset (delta-Y) between adjacent pens.

FIG. 20B shows test patterns formed from aligned and misaligned pen positions shown in FIG. 20A.

FIG. 21A illustrates a horizontal pen-to-pen offset (delta-X) between adjacent pens.

FIG. 21B shows test patterns formed from aligned and misaligned pen positions shown in FIG. 21A.

FIG. 22A schematically illustrates a pen with a nozzle column spacing “d.”

FIG. 22B shows test patterns for good and poor scan axis directionality (SAD).

FIG. 23 shows an exemplary alignment pattern produced by two adjacent pens that can be used to check for pen alignment errors.

FIG. 24 is a flowchart illustrating a method for nozzle health inspection according to one embodiment of the present invention.

FIG. 25 is a flowchart illustrating a method for dot gain detection according to one embodiment of the present invention.

FIG. 26 shows another embodiment in which the optical detection unit is mounted on a platen that supports the print medium during printing.

### DETAILED DESCRIPTION

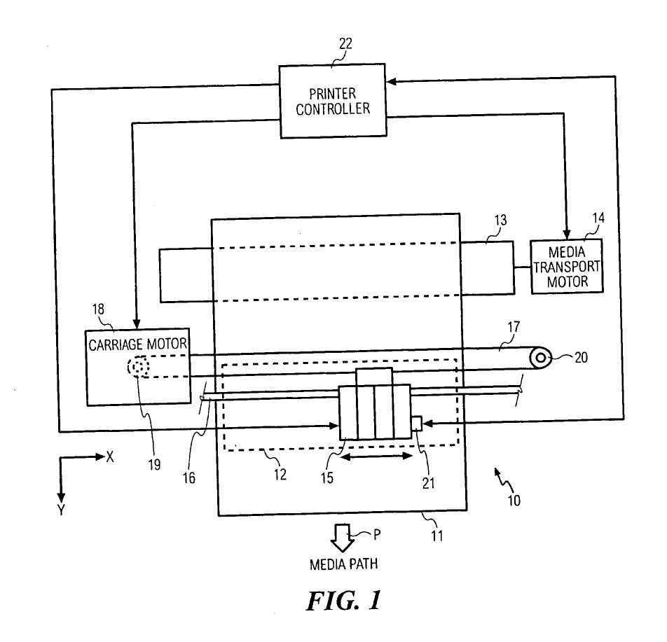

FIG. 1 schematically shows an overview of a printing apparatus 10 with optical detection capability according to an embodiment of the present invention. In this embodiment, the printing apparatus 10 is based on inkjet technology. The printing apparatus 10 includes a media advance mechanism 13 for advancing a print medium 11, e.g. paper, through print zone 12 and a carriage assembly 15 for ejecting ink droplets onto the print medium during printing operation. The media advance mechanism 13 is driven by a media transport motor 14. The carriage assembly 15 is movably mounted on a carriage rod 16. The carriage assembly 15 is connected to a carriage drive belt 17 that is driven by a carriage motor 18 via pulleys 19 and 20. During printing, the carriage assembly 15 moves in a reciprocating manner across the print medium 11 in the X axis, i.e., the scanning path, and the print medium 11 moves in the Y axis, i.e., the media path P, that is transverse to the X direction. The ink ejection direction is along the Z axis, which is orthogonal to the print medium 11. During each sweep of the carriage assembly 15, the print medium 11 is held stationary by the media advance mechanism 13. An optical detection unit 21 is attached to the carriage assembly 15 so that the optical detection unit 21 moves transversely with the carriage assembly. The printing apparatus 10 also includes a printer controller 22 that is electrically coupled to various components of the printing apparatus 10, including the media transport motor 14, the carriage motor 18, the carriage assembly 15, and the optical detection unit 21, to control different aspects of printing and media handling.

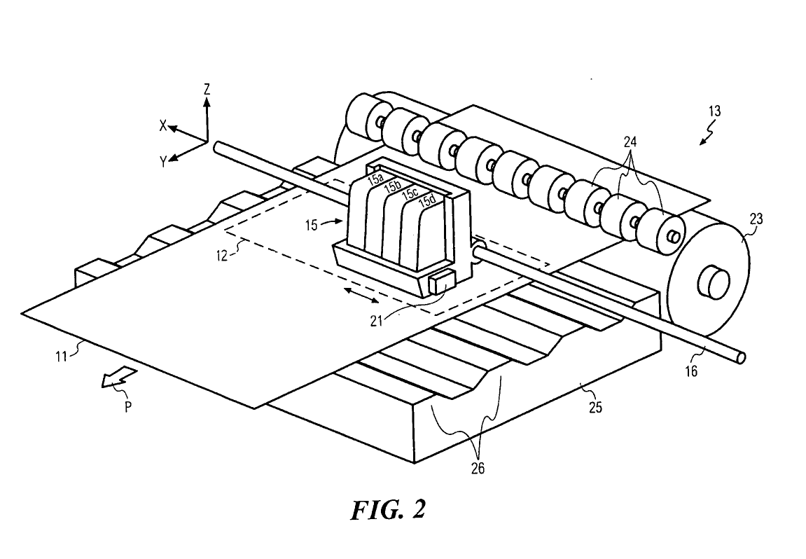

FIG. 2 is one embodiment for the media advance mechanism 13. In this embodiment, the media advance mechanism 13 includes a feed roller 23 and corresponding pinch rollers 24. A platen 25 with ribs 26 is arranged below the carriage assembly 15 for supporting the print medium 11 during printing. The carriage assembly 15 includes a plurality of ink cartridges or pens 15a, 15b, 15c, and 15d that contain inks of different colors, for example, black (K), cyan (C), magenta (M), and yellow (Y). The optical detection unit 21 is attached to one side of the carriage assembly 15 as shown in FIG. 2. Each pen is provided at its lower portion with a printhead (not shown), which is oriented to face the print medium 11. Each printhead is provided with an array of nozzles through which ink droplets are ejected. Although four pens are shown in FIG. 2, it should be understood that only one pen is necessary to print and that any reasonable number of pens may be used.

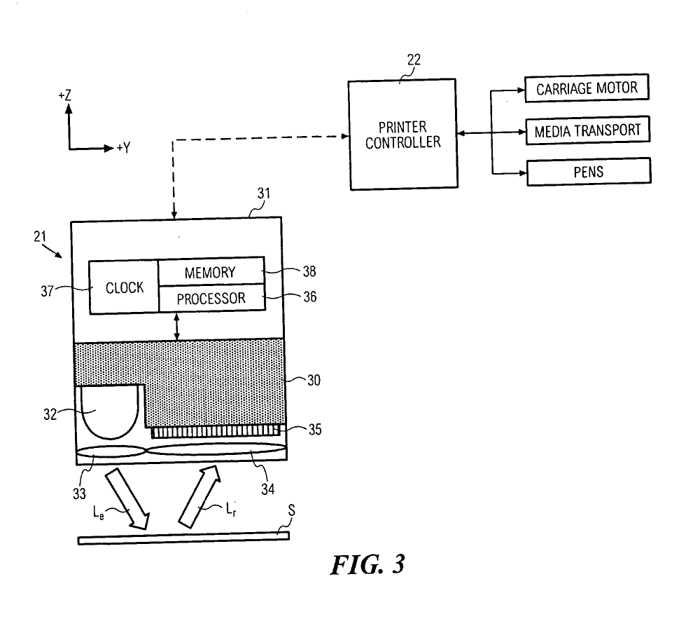

The configuration for the optical detection unit 21 according to one embodiment is illustrated in FIG. 3. In this embodiment, the optical detection unit 21 includes an image acquisition module 30 coupled to an image processing module 31. The image acquisition module 30 may be a CMOS image sensor. The image acquisition module 30 includes a light source 32, e.g. a light emitting diode (LED), a first lens 33 through with the source light is transmitted, a second lens 34 through which the reflected light is transmitted, and a pixel array of photodiode sensors 35 that receives the reflected light. The image processing module 31 includes an image processor 36, a clock 37 for timing the frequency of image capturing and a memory 38 that functions as a buffer for storing digital image signals and/or processed data for pending use. During operation, the light source 32 emits light Lₑ onto the image surface S through the first lens 33. The reflected light Lᵣ passes through light receiving lens 34 and is detected by the pixel array of photodiode sensors 35. The pixel array of photodiode sensors 35 converts the reflected light into voltage signals representing the image that was captured within a given field of view (FOV). The image processor 36 receives the voltage signals and performs a pixel array analysis of the captured image. The output data from the image processing module 31 is sent to printer controller 22. The printer controller 22 is configured to trigger the optical detection unit 21 and to receive the analysis from the optical detection unit 21. In addition, the printer controller 22 is operable to adjust various printing components, including the media transport motor 14, the pens 15a-15d, and the carriage motor 18, based on the output data from the image processing module 31.

Media Movement Detection

Conventionally, in order to improve the accuracy with which the print media advances, media advance mechanisms are often provided with servo motors and closed-loop motor control systems The closed-loop motor control system utilizes an optical encoder coupled to the feed roller and the media position is indirectly derived from the encoder's position. Thus, the encoder position only indirectly reflects the actual position of the media. As a result, errors in the media advance mechanisms, e.g. media slippage, misalignment of the drive gears, would yield inaccurate indication of media position. The optical detection unit of present invention directly monitors the media movement, thereby providing a more accurate feedback of the media position.

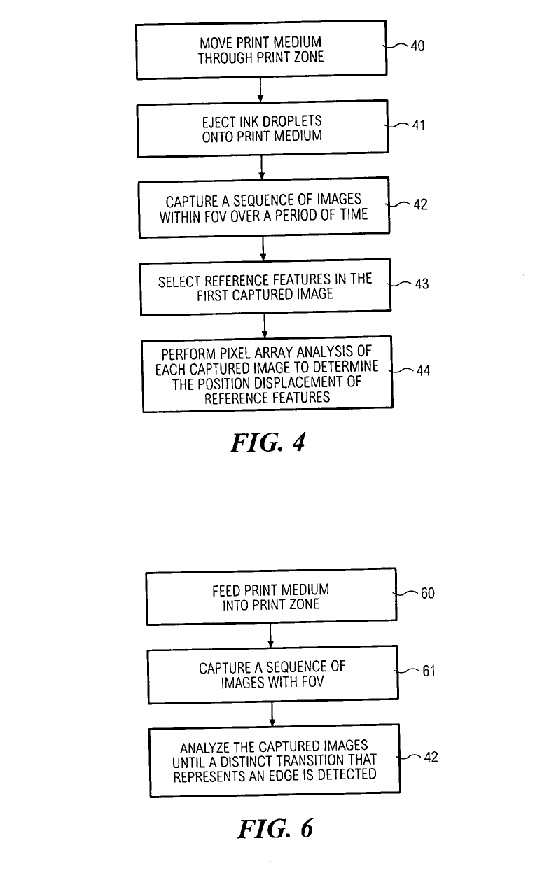

FIG. 4 is a flowchart illustrating a method of monitoring the print medium movement during printing using the optical detection unit 21 of FIG. 3. At step 40, the print medium is moved through the print zone. At step 41, printing is carried out by ejecting ink droplets onto the print medium. At step 42, as the print medium advances through the print zone during printing, the image acquisition module 30 captures a sequence of images of the print medium within a FOV over a period of time. Next, reference features are selected from the first captured image at step 43. Pixel array analysis of each captured image is performed at step 44 by the image processor 36 to determine the position displacement of the reference features during this time period. This pixel array analysis includes analyzing the pixel value data of each captured image by using a local sensing coordinate system defined by the FOV. The pixel array analysis may be done after all the required images have been captured, or alternatively, after each image is captured. The pixel value data at each local coordinate location in the first captured image is compared with the pixel value data at the same local coordinate location in subsequently captured images to track the movement of the reference features. The image processor 36 may be provided with any suitable algorithm capable of performing this tracking task. When the image acquisition module 30 is capturing the print media movement, the carriage assembly 15 could be in any dynamic position above the print zone. The FOV of the image acquisition module may or may not be fixed during this time period. At any moment during image capturing, the image acquisition module can capture the 2-dimensional (2D) image of the reference features on the print medium. Because the carriage assembly's moving direction and the medium's moving direction are perpendicular to each other, pixel array analysis of the images sampled during this time period will give the printer controller 2D components in the X and Y directions that represent the change in position over time of both the carriage assembly and the print media. Therefore, the accumulative displacement would provide the printer controller with position displacement information of both the carriage assembly and the print medium over the sampled time period.

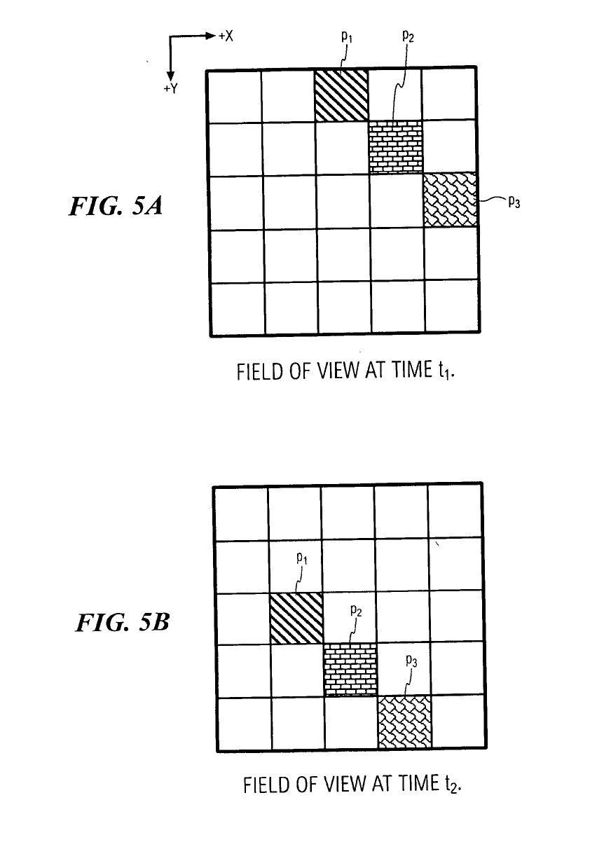

As illustration, FIGS. 5A and 5B show two sequentially acquired images within a FOV. At time t₁, the acquired image contains reference features p₁, p₂, p₃ at a certain position (FIG. 5A). At time t₂, the reference features have moved 1 pixel in the negative X direction and 2 pixels in the positive Y direction (FIG. 5B). The movement of the reference features represents the movement of the print medium when the FOV coordinate system is aligned with the coordinate system of the print medium and the carriage assembly.

Referring again to FIGS. 1-3, the position data output from the image processing module 31 is sent to printer controller 22 as dual-channel signals (x and y directions). The signals may or may not be configured by the image processing module 31 to emulate a quadrature signal, commonly used by printer controllers for positional control of motors. The printer controller 22 applies a coordinate transformation algorithm to convert the signals into moving positions of the media and carriage assembly in an (X, Y) coordinate. This transformed position data is used to control the media transport motor 14 or the carriage motor 18. If the position data from the image processing module indicates that either the print medium 11 or the carriage assembly 15 has moved out of the desired position, the printer controller 22 would generate a correction command for adjusting the media transport motor 14 or the carriage motor 18. The frequency of image acquisition depends on the position updating requirement from the printer controller 22.

In one embodiment, the printer controller 22 is provided with a closed-loop servo positioning system for controlling the media transport motor 14. In this embodiment, the position data from the image processing module 31 is sent to the servo positioning system, which in turn operates the media transport motor 14 accordingly.

Edge Detection and Skew Compensation

The optical detection unit 21 of the present invention is effective for media edge detection to ensure that the print medium is aligned correctly in the print zone prior to printing. Depending on where the FOV of the image acquisition module 30 is positioned, either the top edge (leading edge) or the side edge, or both may be detected as an incoming print medium enters the print zone.

FIG. 6 is a flowchart illustrating a method for edge detection according to one embodiment of the present invention. At step 60, a print medium is fed into the print zone. The image acquisition module 30 is triggered to capture a sequence of images within the FOV at step 61. At step 62, the image processor 36 analyzes the pixel value data of the captured image(s) until a distinct transition from a light area (representing the print medium) to a dark area (representing the absence of the print medium) is detected. This distinct transition represents an edge of the print medium.

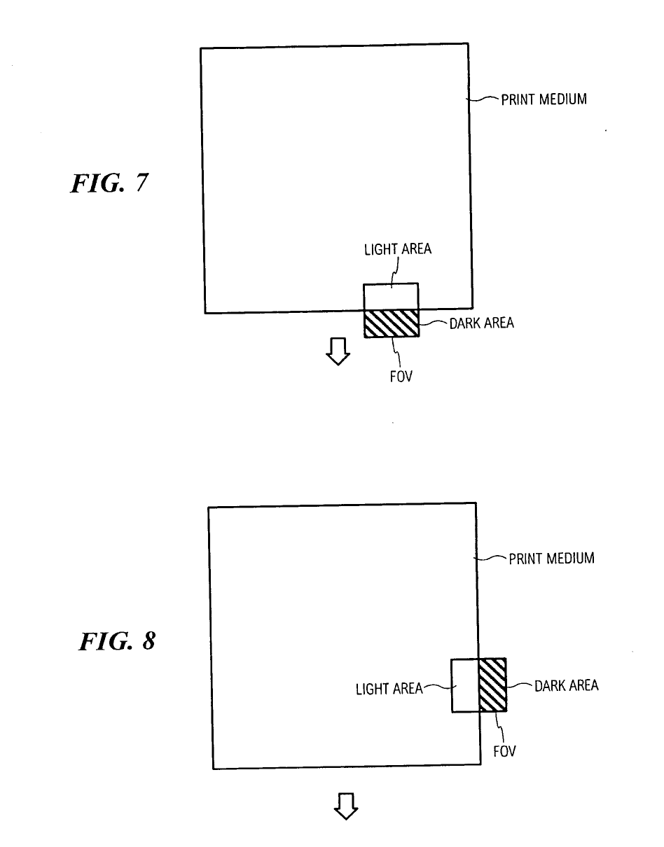

FIG. 7 illustrates a FOV that is positioned to detect the top edge of the print medium. The dark area represents the supporting platen and the light area represents the print medium. As the print medium enters the print zone, the image acquisition module 30 is triggered to capture a sequence of images within the FOV. By analyzing the captured images, the top edge is detected when the top edge enters the FOV. Top edge detection is useful for checking whether the print medium is correctly positioned in the print zone before the first printing sweep by the inkjet pens.

FIG. 8 shows an arrangement in which the FOV is positioned to detect a side edge of the print medium. After the print medium is loaded into the print zone, a sequence of images is captured by the image acquisition module 30 as the carriage assembly 15 is moved along the carriage rod 16 in the X direction. The captured images are analyzed by the image processor 36 until the side edge is within the FOV. In one embodiment, the carriage assembly is moved along the X direction at a predetermined image capturing frequency to ensure the FOV can capture the side edge. A side edge is not found unless there are two clearly defined areas within the FOV, one dark and one light, with a straight boundary between them. The side edge detection is useful for preventing accidental printing on the platen when a print medium with a narrower than specified width is used.

In print media handling applications, it is desirable to minimize skew, wherein “skew” is defined as the misalignment between the boundary of the print medium and the printed image. An angle formed between the length axis of the print medium and the length axis of the printed image is known as “skew angle.” Skew may be caused by, but is not limited to, the incorrect feeding of the print medium into the print zone by the media advance mechanism. When a print medium is fed with a side skew, a fixed position FOV will capture the media side edge gradually shifting along the printer's X axis in successively captured images. The printing apparatus of the present invention is provided with any conventional hardware and/or software skew compensation when media skew is detected.

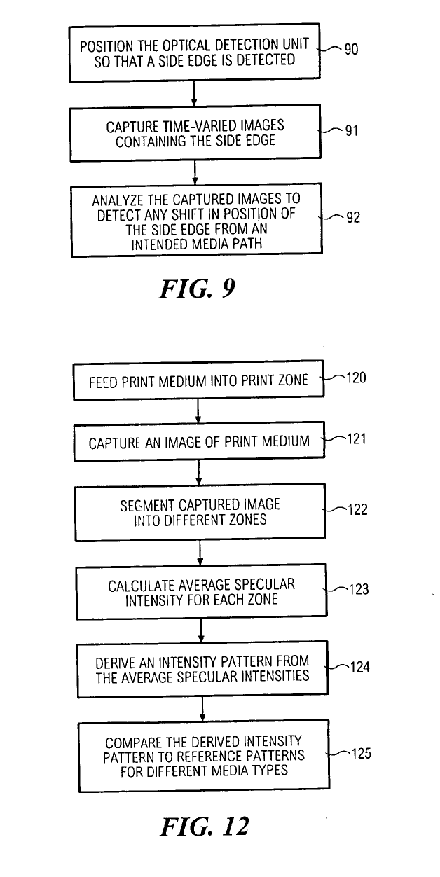

FIG. 9 is a flowchart illustrating a skew detection method according to one embodiment of the present invention. At step 90, the optical detection unit 21 is positioned so that a side edge is detected. At step 91, time-varied images containing the moving side edge are captured. At step 92, the captured images are analyzed to detect any shift in position of the side edge from an intended media path.

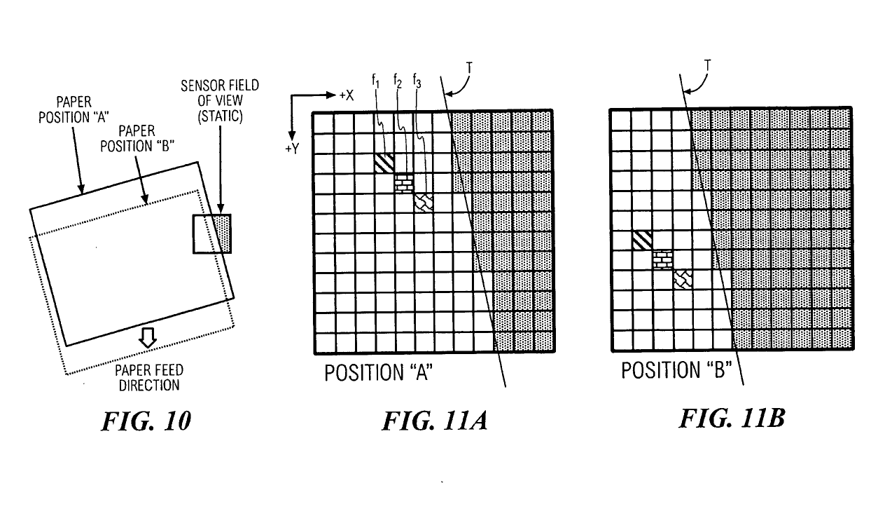

The FIG. 10 illustrates a shift in position of the print medium from position A to position B when there is a static skew. The FOV is fixed relative to the shifting print medium in order to detect the shift. To perform skew detection during the advancement of the print medium through the print zone, the optical detection unit 21 together with the carriage assembly 15 move in the carriage scanning direction to a position that can detect a side edge of the advancing print medium. A first image captured at this position will define the side edge location of the print medium with respect to the FOV sensing coordinate system. When the print medium is in a skewed state, the medium is shifted in the X direction. With the image acquisition module 30 together with the carriage assembly 15 remaining in the same position, a second image is captured. The current side edge location is then compared to the previously determined edge location using the image processor 36. A displacement of the side edge within the FOV sensing coordinate system will define the skew of the print medium as illustrated by FIG. 10.

As illustration, FIGS. 11a and 11b show the captured images at position A and position B, respectively. For simplicity, only two captured images are shown, but it should be understood that more than two time-varied images are possible. Referring to FIG. 11a, the distinct transition T between dark and light areas is identified for the captured image at position A. The shift in the position of the side edge is determined by analyzing the captured image at position B (FIG. 11b) to determine the displacement of the distinct transition T. FIGS. 11a and 11b show that the distinct transition T and the reference features f₁, f₂, f₃ have moved in the −X direction as well as the +Y direction. This data would be interpreted by the image processor as a skewed condition.

It may be advantageous to check for misalignment of FOV sensing coordinate system relative to the XY plane coordinate system of the printing apparatus. It is the XY plane coordinate system of the printing apparatus which determines the print medium location with respect to the printing apparatus. If such misalignment is determined, the printer controller may be provided with a skew determination algorithm that includes a compensation value to correct such misalignment. If uncorrected, this misalignment would affect the determination of the actual skew.

Media Type Detection

The printing apparatus of the present invention is operable to print different types of print media (e.g. transparencies, plain paper, premium paper, photographic paper, etc.). By having the arrangement of the optical detection unit 21 as discussed above, the type of print medium entering the print zone can be detected so that the printing mechanisms can automatically tailor the printing mode to generate optimal images on the specific type of print medium.

FIG. 12 is a flowchart illustrating a method for media type detection according to one embodiment of the present invention. At step 120, the print medium is fed into the print zone. When the print medium is at the “top of form” position in the print zone (i.e., before first printing swath), the image acquisition module 30 is triggered to capture at least one image of the print medium at step 121. One captured image is usually sufficient for distinguishing among plain paper, transparency and photographic media. The pixel value data of the captured image is then analyzed by the image processor 36 to identify the type of media. The pixel value data is analyzed by collecting the specular data, or the light to voltage value, for each photodiode pixel. This analysis includes steps 122-125 shown in FIG. 12. At step 122, the captured image is segmented into different zones. At step 123, a conventional averaging method is applied to the specular data within each zone to define an average specular intensity for each zone. At step 124, an intensity pattern is then derived from the average specular intensities of different zones. This intensity pattern is compared with empirically derived reference patterns for different media types at step 125. The reference patterns are stored in either the memory 38 of the image processing module 31, or in the memory of the printer controller 22. When a match is found between a reference pattern for a particular media type and the intensity pattern derived from the captured image, the media type of the print medium can be identified.

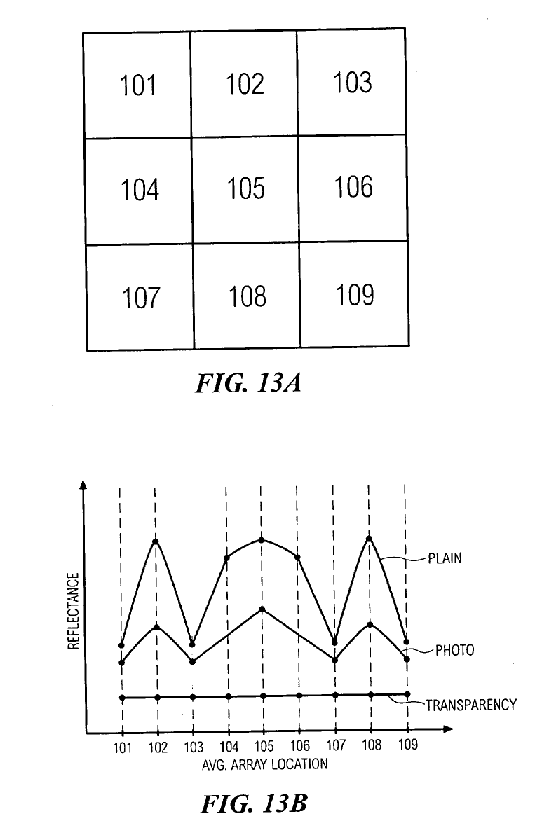

FIG. 13A illustrates an exemplary captured image that has been segmented into nine zones 101-109. The average specular intensity for each zone is calculated. If the average specular intensities of zones 101, 103, 107, 109 are much greater than the average specular intensities of zones 102, 104, 105, 106, 108, then the print medium is a plain paper. If average specular intensities of zones 101-104, and 106-109 are much greater than the average specular intensity of zone 105, then the print medium is a photographic paper. If average specular intensities for zones 101-109 are approximately zero, then the print medium is a transparency. FIG. 13B is a graph showing how the intensity patterns derived for plain, photographic, and transparent media are different from one another.

One advantage of the optical detection unit 21 of the present invention is that a higher resolution of multi-dimensional reflectance data is possible. Furthermore, this optical detection unit is capable of capturing separate RGB channels, which could provide additional dimensions to data interpretation for differentiating one media type from another. For example, an ivory textured greeting card may be differentiated from a white textured greeting card, and the printing process can be tailored accordingly to optimize the image quality for either of the media types.

Energy Level Determination

A variety of different conventional printheads may be utilized for the printing apparatus of the present invention. Some examples of suitable printheads include thermal printheads, piezo-electric printheads, and silicon electrostatic actuator printheads. For each type of printhead, an operational turn-on energy (TOE) is required for ejecting ink droplets of a certain volume through the printhead's nozzles. With the arrangement of the optical detection unit 21 of the present invention, a simplified method of determining the operational TOE can be achieved.

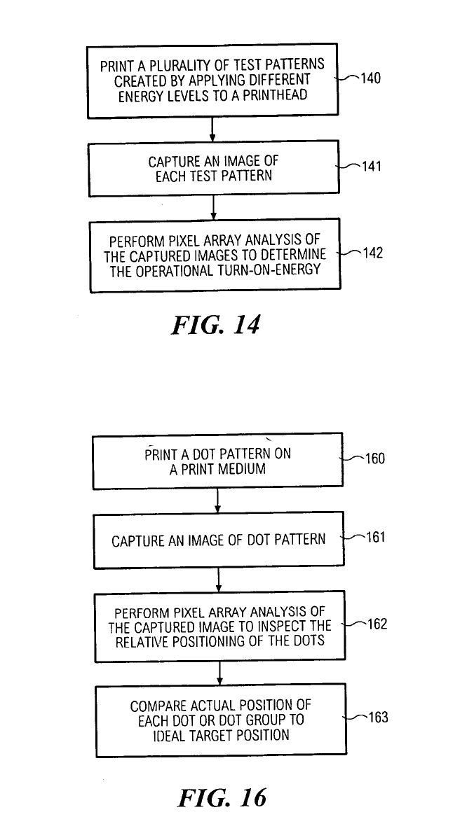

FIG. 14 is a flowchart illustrating a method for determining an operational TOE according to one embodiment of the present invention. At step 140, the method of determining the TOE begins with printing a plurality of test patterns, which are created by applying different energy levels to a printhead, starting from a high energy level to no energy. The image acquisition module 30 is then triggered to capture an image of each test pattern at step 141. The captured images are analyzed by the image processor 36 at step 142. Typically, the printhead will cease to eject ink droplets below a certain threshold of energy, and this threshold is significantly above zero. The highest energy level is selected such that it will be significantly above an energy level below which will cause printhead ejection of droplets to become unstable. This instability usually shows up as incomplete droplet formation and/or ejection that causes the printed pattern to contain defects such as incomplete and/or missing dots. After passing the image acquisition module 30 over each of the printed test patterns, image processing of the captured images indicates which pattern begins to have incompleteness beyond an acceptable level. Thus, by knowing the pattern that goes beyond the acceptable level, the minimum acceptable TOE level can be selected.

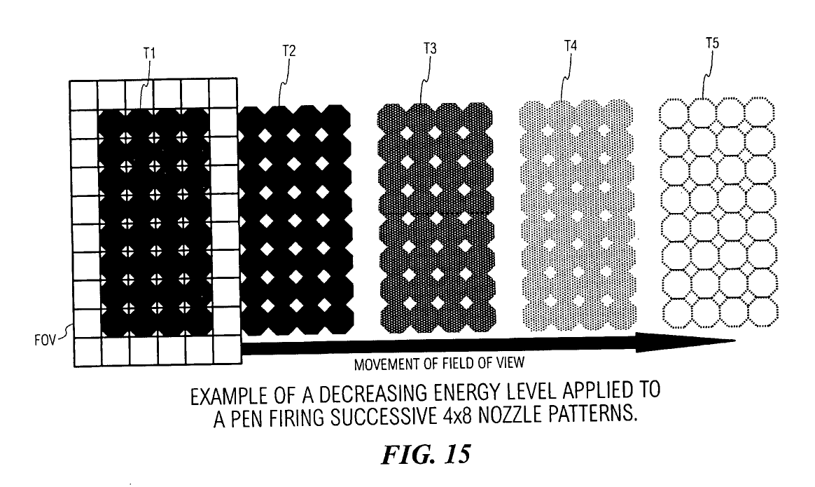

FIG. 15 shows the FOV of the image acquisition module 30 passing over exemplary test patterns T1-T5, in the direction shown by the arrow, to capture the image of each test pattern. The test patterns are created by applying decreasing energy levels to a printhead which prints an 8×4 pixel array pattern per energy level. Test pattern T1 is formed from applying the highest energy level and test pattern T5 represents the disappearance of ink droplets at zero energy. In this example, T3 represents the energy level that causes a deterioration of the printed output. Therefore, the operational TOE will be set just above this level with a margin of an over-energy level to account for any variation over the printing life of the printing apparatus.

By performing a pixel array analysis of the captured images of the test patterns as discussed above, the operational TOE level for each nozzle can also be determined. This is possible because each printed dot row can be individually evaluated by the image processor. With this specific energy information, the printer controller gains flexibility in applying optimum energy levels across all printhead nozzles, thereby allowing for TOE variations among nozzles or nozzle groups. This is an advantage over prior art methods, which calculate TOE based on a single signal response obtained from scanning a plurality of printed dot rows.

Pen Alignment

Misalignment of the printhead may result in an offset in the positioning of the ink dots on the print medium. Such linear misalignments may occur in the X direction (i.e., the media advance axis) or the Y direction (i.e., the scan axis), or the Z direction (i.e. the ink ejection direction from pen to print medium), and are referred to as delta-X, delta-Y and delta-Z, respectively. Rotational misalignments of the printhead may occur about the X, Y or Z axes and are referred to as theta-X (printhead planar pitch), theta-Y (roll) and theta-Z (yaw). These misalignments will either independently, or in combination, result in 2D XY offsets in the positioning of ink dots on the print medium.

According to one embodiment of the present invention, a simplified method for detecting pen misalignment is illustrated in FIG. 16. This detection method is carried out by the optical detection unit 21 described above. At step 160, a dot pattern is formed on a print medium. This dot pattern is formed by a forward sweep and a return sweep of the carriage assembly. The image of the dot pattern is then captured by the image acquisition module 30 at step 161. At step 162, pixel array analysis of the captured image is performed by the image processor 36 to inspect the relative positioning of the dots within the FOV of the image acquisition module 30. A comparison is then made between the actual position of each dot (or dot group) and the ideal target position at step 163. The decision to look at either individual dots, or dot groups will be dependent upon the alignment parameters being considered. If the comparison yields any difference between the actual and ideal target positions, there is a misalignment of the printhead that results in an offset in the position of the printed dots in the XY plane. This 2-D XY offset of the dots requires correction and is compensated by either substituting the original nozzles with other nozzles, or by adjusting the firing characteristics of the original nozzles themselves. The misalignment correction is automatically done by the printer controller upon receiving the misalignment data from the image processing unit. Different pen alignment parameters can be considered by creating the appropriate dot patterns using different groups of nozzles. By this method, inter-pen and intra-pen offsets can be detected.

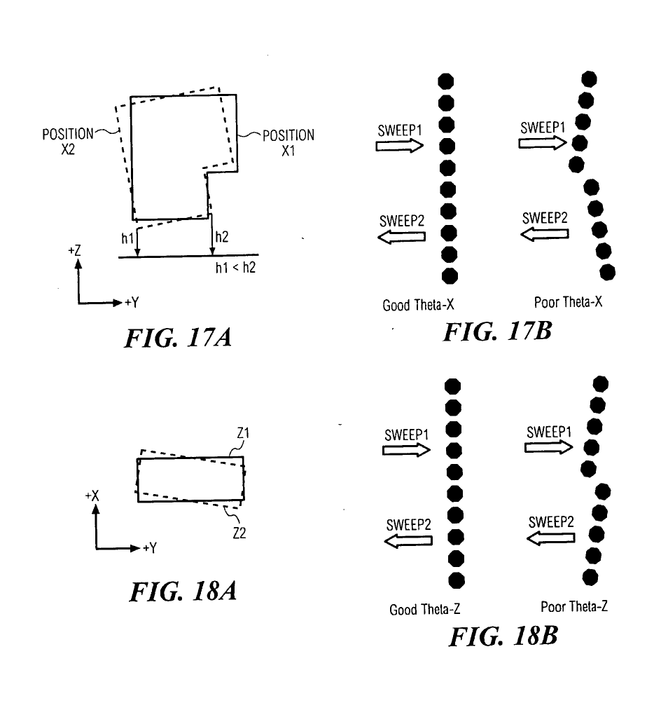

Exemplary test patterns for detecting misalignment due to different pen alignment parameters will now be described. FIG. 17A illustrates the difference between a correctly aligned pen position X1 and a misaligned pen position X2 with theta-X offset. In FIG. 17A, theta-X occurs because h₁<h₂. Theta-X occurs when h₁≠h₂. FIG. 17B shows the test patterns formed from pen position X1 (good theta-X) and pen position X2 (poor theta-X). Each test pattern is a result of a forward sweep (SWEEP1) and a turn sweep (SWEEP2) of the pen.

FIG. 18A illustrates the difference between a correctly aligned pen position Z1 and a misaligned pen position Z2 with theta-Z offset. FIG. 18B shows the test patterns formed from pen position Z1 (good theta-Z) and pen position Z2 (poor theta-Z).

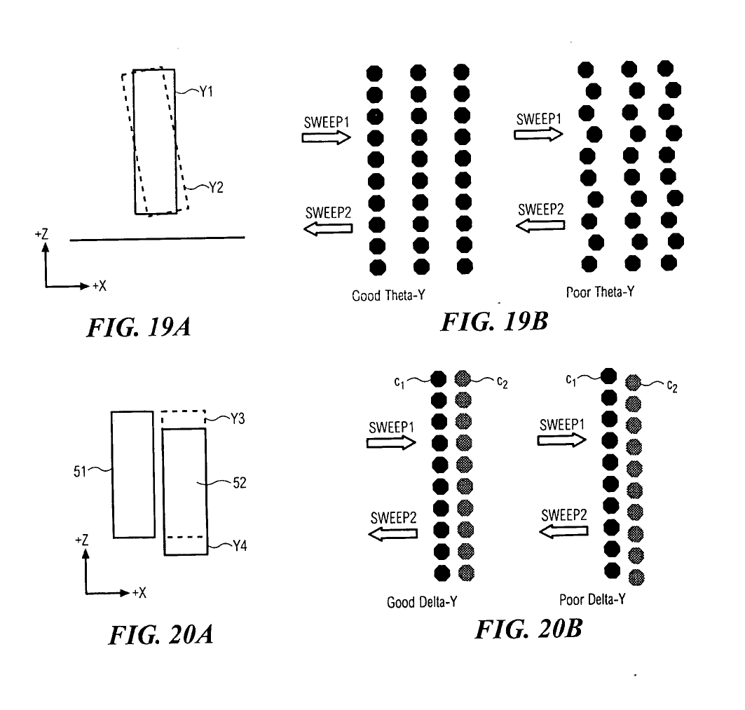

FIG. 19A illustrates the difference between a correctly aligned pen position Y1 and a misaligned pen position Y2 with theta-Y offset. FIG. 19B shows the test patterns formed from pen position Y1 (good theta-Y) and pen position Y2 (poor theta-Y).

FIG. 20A illustrates a vertical pen-to-pen offset (delta-Y) between adjacent pens 51 and 52. In FIG. 20A, the pens are aligned when pen 52 is at position Y3 (phantom outline), and misaligned when pen 52 is at position Y4. FIG. 20B shows the test patterns formed from aligned pens and misaligned pens. Dot column c₁ is formed by pen 51, and dot column c₂ is formed by pen 52.

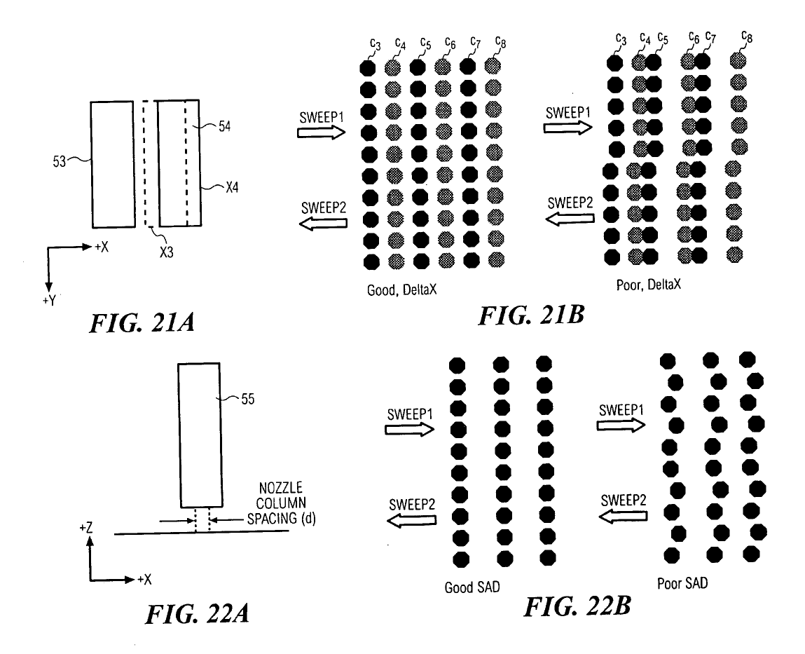

FIG. 21A illustrates a horizontal pen-to-pen offset (delta-X) between adjacent pens 53 and 54. In FIG. 21A, the pens are aligned when pen 54 is at position X3 (phantom outline), and misaligned when pen 54 is at position X4. FIG. 21B shows the test patterns formed from aligned pens and misaligned pens. Dot columns c₃, c₅, c₇ are formed by pen 53, and dot columns c₄, c₆, c₈ are formed by pen 54.

Scan axis directionality (SAD) errors, also known as column separation errors, are errors in the droplet ejection direction with respect to the nozzle plate in the plane XZ. SAD error is measured as a nozzle column to nozzle column offset. FIG. 22A schematically illustrates a pen 55 with a nozzle column spacing d. FIG. 22B shows the difference between a test pattern resulted from good SAD of that from poor SAD.

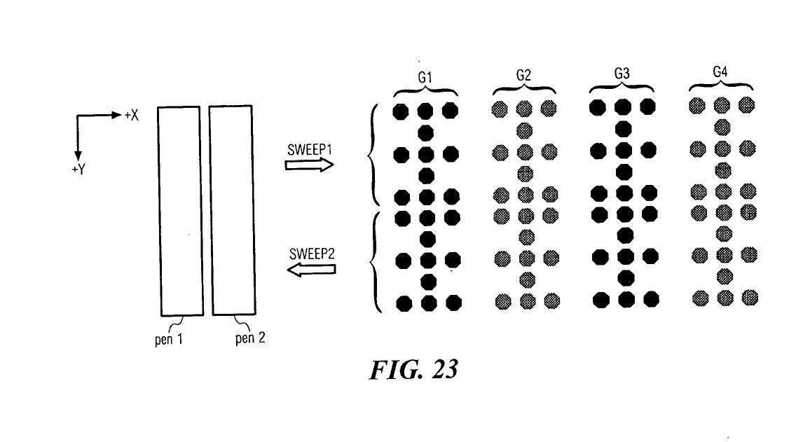

FIG. 23 shows an exemplary alignment pattern produced by two adjacent pens 1 and 2. This pattern can be used to check for errors relating to linear offsets (delta-X, delta-Y and delta-Z) and rotational offsets (theta-X, theta-Y and theta-Z). Dot patterns G1 and G3 are produced by pen 1 and dot patterns G2 and G4 are produced by pen 2. This exemplary alignment pattern represents a target pattern created by a selected group of nozzles, and any deviation from this pattern can be detected as alignment error.

Nozzle Health Inspection

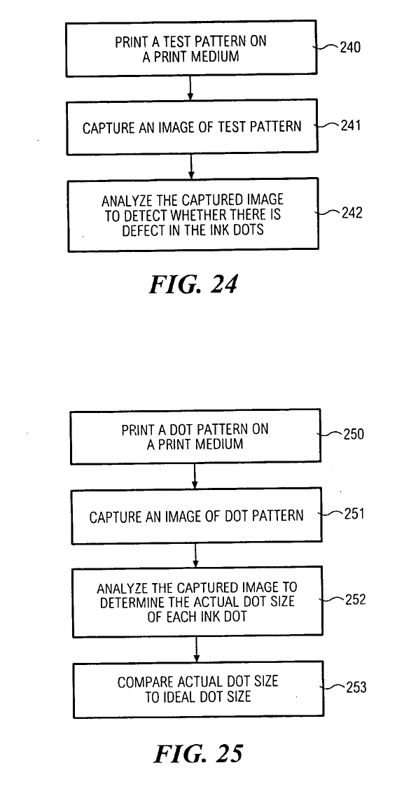

Using the optical detection unit 21 of the present invention, the nozzle health can be inspected. FIG. 24 is a flowchart illustrating a method for nozzle health inspection according to one embodiment of the present invention. This method includes printing a simple test pattern on a print medium (step 240) and capturing the image of the test pattern (step 241). The captured image is then analyzed (step 242) to detect whether there is a defect in the ink dots, e.g. missing ink dots (due to missing nozzles) or incompletely-formed ink dots (due to partially plugged nozzles). Mis-directed dots (due to mis-fired nozzles) can also be determined by comparing the actual ink drops to their ideal target positions. Beside from being able to differentiate between a well-formed printed dot and an incompletely-formed printed dot, another advantage of this method is the ability to locate misdirected nozzles. If the image analysis reveals a higher pixel coverage in an expected dot location, and an adjacent missing nozzle is detected, then it may be concluded that a misdirected nozzle exists at the apparent missing nozzle location. Alternatively, if the image analysis does not reveal a higher pixel coverage in an expected dot location next to an apparent missing nozzle, then it may be concluded that there is a missing nozzle.

Dot Gain Detection

Dot gain is the ratio between an initial drop diameter, which is produced during first interaction between the ink and the print medium, and the final drop diameter after drying. In inkjet printing, dot gain is caused mainly by ink bleed, which is a function of the characteristics of the ink and the media type. Using the optical detection unit 21 described above, dot gain can be detected for each individual ink dot. FIG. 25 is a flowchart illustrating a method for dot gain detection according to one embodiment of the present invention. This method includes printing a simple dot pattern on a print medium (step 250) and capturing an image of the dot pattern (step 251). The captured image is then analyzed at the pixel level to determine the actual dot size of each ink dot (step 252). The actual dot size is compared to an ideal dot size to detect dot gain (step 253). Dot gain detection is typically performed during the installation of a new printhead in order to adjust the ink droplet volume either directly by controlling the energy applied to the pen, or indirectly through depletion of ink dots on the print medium. This adjustment technique results in a close approximation of an ideal dot size.

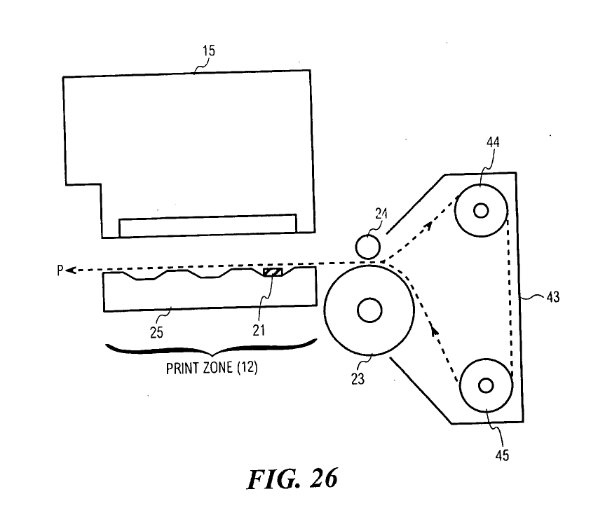

In the embodiments above, the optical detection unit 21 is mounted on the carriage assembly 15. FIG. 26 shows another embodiment of the present invention, wherein the optical detection unit 21 is mounted on the platen 25. This arrangement is appropriate when the printing apparatus is further provided with a duplexing mechanism 43. In this embodiment, the duplex mechanism 43 includes duplex rollers 44 and 45. During operation, after the first side of the print medium is printed, the print medium is pulled back into the duplex mechanism 43 and passed over rollers 44 and 45, thereby flipping the print medium, then the flipped print medium is returned to the print zone 12 for second-side printing. It should be understood that any conventional duplexing mechanism may be provided and details of which are known to those skilled in the art. The optical detection unit 21 in this position is capable of all of the same functions described above for the carriage-mounted position except detecting the movement of the carriage assembly 15 during printing.

It is intended that the embodiments contained in the above description and shown in the accompanying drawings are illustrative and not limiting. It will be clear to those skilled in the art that modifications may be made to these embodiments without departing from the scope of the invention as defined by the appended claims.

What is claimed is:

1. An apparatus for performing a printing operation comprising:
advancement mechanism for advancing a print medium through a print zone;
a carriage assembly having at least one ink pen for ejecting ink droplets onto the print medium in the print zone;
a carriage transport mechanism operable to move the carriage assembly relative to the print medium;
an optical detection unit positioned in the print zone, said optical detection unit comprising an image acquisition module for capturing at least one image in the print zone within a field of view and an image processor for performing a pixel array analysis of the captured image; and
a printer controller connected to the optical detection unit for triggering the optical detection unit and controlling the printing operation based on the pixel array analysis.

2. The printing apparatus of claim 1, wherein the optical detection unit is mounted on the carriage assembly.

3. The printing apparatus of claim 1 further comprising a platen for supporting the print medium in the print zone and a duplexing mechanism,
wherein the optical detection unit is mounted on the platen.

4. A method of print quality control comprising.
moving a print medium through a print zone;
positioning an optical detection unit in the print zone, said optical detection unit comprising an image acquisition module and an image processor;
ejecting ink droplets onto the print medium in the print zone;
capturing a plurality of time-varied images of the print medium using said image acquisition module; and
performing pixel array analysis of the captured images using said image processor to detect the movement of the print medium,
wherein said pixel array analysis comprises:
(i) identifying a reference feature in the captured images; and
(ii) determining position displacement of the reference feature over time.

5. A method of print quality control comprising:
moving a print medium through a print zone;
positioning a movable carriage assembly in the print zone, said carriage assembly having at least one ink pen and an optical detection unit, said optical detection unit comprising an image acquisition module and an image processor;
ejecting ink droplets onto the print medium using the ink pen while moving the carriage assembly relative to the print medium;
capturing a sequence of time-varied images of the print medium using said image acquisition module; and
performing pixel array analysis of the captured images using said image processor to detect the movement of the print medium and the carriage assembly,
wherein said pixel array analysis comprises:
(i) identifying a reference feature in the captured images; and
(ii) determining position displacement of the reference feature over time.

6. A method of edge detection during a printing operation comprising:
feeding a print medium into a print zone;
positioning an optical detection unit in the print zone, said optical detection unit comprising an image acquisition module with a field of view and an image processor;
capturing a sequence of images of the print zone using said image acquisition module; and
performing pixel array analysis of the captured images using said image processor to detect a distinct transition representing an edge of the print medium.

7. The method of print quality control of claim 6, wherein the edge detected is a top edge.

8. The method of print quality control of claim 6, wherein the edge detected is a side edge.

9. A method of print quality control comprising:
advancing a print medium through a print zone along a media path;
positioning an optical detection unit in the print zone, said optical detection unit comprising an image acquisition module with a field of view and an image processor, said image acquisition module is positioned so that a side edge of the print medium can enter the field of view;
capturing a sequence of time-varied images containing the side edge of the advancing print medium using said image acquisition module; and
performing pixel array analysis of the captured images using said image processor to detect whether there is a shift in position of the side edge from the media path.

10. A method of print quality control comprising:
advancing a print medium through a print zone;
providing at least one ink pen in the print zone, each ink pen having a printhead for ejecting ink droplets on the print medium;
positioning an optical detection unit in the print zone, said optical detection unit comprising an image acquisition module and an image processor;
printing a plurality of test patterns on the print medium by applying different turn-on-energy levels to the printhead;
capturing an image of each test pattern using said image acquisition module; and
performing pixel array analysis of the captured images using the image processor to determine an operational turn-on-energy for the printhead.

11. A method of pen alignment comprising:
advancing a print medium through a print zone;
providing at least one ink pen in the print zone, said ink pen being provided with a printhead for ejecting ink droplets that form ink dots on the print medium;
positioning an optical detection unit in the print zone, said optical detection unit comprising an image acquisition module and an image processor;
printing an alignment pattern of ink dots on the print medium using said at least one ink pen;
capturing an image of the alignment pattern using said image acquisition module;
performing pixel array analysis of the captured image using sai image processor to inspect the relative positioning of the ink dots; and
comparing the actual position of the ink dots to their ideal position.

12. A method of nozzle health inspection comprising:
advancing a print medium through a print zone;
providing at least one ink pen in the print zone, said ink pen being provided with nozzles for ejecting ink droplets that form dots on the print medium;
positioning an optical detection unit adjacent to the print medium in the print zone, the optical detection unit comprising an image acquisition module and an image processor;
ejecting ink droplets to form ink dots on the print medium using said at least one ink pen;
capturing at least one image of the ink dots using said image acquisition module; and
performing pixel array analysis of the captured image using said image processor to detect whether there is a defect in the ink dots.

13. The method of claim 12, wherein said defect comprises a missing ink dot caused by a missing nozzle.

14. The method of claim 12, wherein said defect comprises an incompletely-formed ink dot caused by a partially plugged nozzle.

15. A method for determining media type comprising:
advancing a print medium through a print zone;
positioning an optical detection unit adjacent to the print medium in the print zone, the optical detection unit comprising an image acquisition module and an image processor;
capturing an image of the print medium using said image acquisition module; and
performing a pixel array analysis of the captured image using said image processor to determine the media type,
wherein said pixel array analysis comprises:
(i) dividing the captured image into different zones;
(ii) calculating an average specular intensity for each zone;
(iii) deriving an intensity pattern from the average specular intensities; and
(iv) comparing the derived intensity pattern to reference patterns for various media types.

16. A method for dot gain detection comprising:
advancing a print medium through a print zone;
positioning an optical detection unit adjacent to the print medium in the print zone, the optical detection unit comprising an image acquisition module for capturing at least one image of the medium within a field of view and an image processor for performing a pixel array analysis of the captured image;
ejecting ink droplets to form ink dots on the print medium;
capturing at least one image of the ink dots using said image acquisition module;
performing pixel array analysis of the captured image using said image processor to determine the actual dot size of each ink dot; and
comparing the actual dot size to an ideal dot size.
